(19) United States
(12) Patent Application Publication
(10) Pub. No.: US 2013/0108878 A1
(43) Pub. Date: May 2, 2013

(54) HYBRID PART OF A MOTOR VEHICLE AND METHOD FOR THE PRODUCTION OF SUCH HYBRID PART OF A MOTOR VEHICLE

(71) Applicant: Benteler Automobiltechnik GmbH, Paderborn (DE)

(72) Inventors: MARKUS KLEINE, Erwitte (DE); WALDEMAR DINIUS, Paderborn (DE); STEFAN WILLEIT, Werther/Westfalen (DE); JORGE FREITAS, Soest (DE); SERGEJ SCHÄFER, Paderborn (DE); MARCEL FEJCARUK, Paderborn (DE); DIETER THIELE, Salzkotten (DE); UDO RHODE, Paderborn (DE); PETER SMITH, Paderborn (DE); NORBERT BADKE, Bad Lippsringe (DE)

(73) Assignee: Benteler Automobiltechnik GmbH, Paderborn (DE)

(21) Appl. No.: 13/657,456

(22) Filed: Oct. 22, 2012

(30) Foreign Application Priority Data
Oct. 28, 2011 (DE) 10 2011 054 915.3

(51) Int. Cl. B29C 35/02

(52) U.S. Cl. CPC B29C 35/02
USPC 428/457; 264/138; 264/493

(57) ABSTRACT

In a method of making a hybrid part of a motor vehicle, a base body is produced in the form of a three-dimensional component, and a layer of fiber material is treated by adding resin to the fiber material. After cutting the fiber material to size for producing a blank, the blank is placed on a preform and heated on the preform. The base body is positioned above the blank and the blank is molded onto the base body by pressing the base body and/or the preform against the blank. The blank is then allowed to harden to provide a reinforcement patch in the base body.

### CROSS-REFERENCES TO RELATED APPLICATIONS

This application claims the priority of German Patent Application, Serial No. 10 2011 054 915.3, filed Oct. 28, 2011, pursuant to 35 U.S.C. 119(a)-(d), the content of which is incorporated herein by reference in its entirety as if fully set forth herein.

### BACKGROUND OF THE INVENTION

The present invention relates to a hybrid part of a motor vehicle, and to a method for the production of such hybrid part of a motor vehicle.

The following discussion of related art is provided to assist the reader in understanding the advantages of the invention, and is not to be construed as an admission that this related art is prior art to this invention.

Automobile manufacturers strive to produce fuel-efficient vehicles with little CO₂ emission. One approach to save fuel involves the development of novel engines which have a constant power output with significantly less fuel consumption by using, for example, charging processes of the combustion engine. Increasingly, the use of hybrid vehicles is proposed which employ an electric drive in addition to the combustion engine. Other options involve an improvement of flow characteristics of a motor vehicle so as to provide a better cw value that saves fuel during operation of the vehicle. Fuel consumption can also be lowered by reducing the weight of the motor vehicle through use of light metal alloys or high-strength and/or ultra-high-strength steels for body construction. As a result, significantly less mass is required to be moved, thereby saving fuel and thus CO₂ emission.

Increasingly the use of fiber composites has been proposed for body construction or also the use of hybrid parts that are made of metal and fiber composite. For example, engine hoods, doors, trunk lids, fenders but also roof panels or other body parts and body structures are made from light metal. As the manufacturing process for automated production of fiber composites continuously progresses, overall production becomes more efficient not only for prototype construction, racing cars or luxury cars but automated production of fiber composite parts is available also for midsized cars.

It would be desirable and advantageous to address prior art shortcomings.

### SUMMARY OF THE INVENTION

According to one aspect of the present invention, a method of making a hybrid part of a motor vehicle includes producing a base body in the form of a three-dimensional component, adding resin to a layer of fiber material, cutting the fiber material to size for producing a blank, placing the blank on a preform, heating the blank on the preform, positioning the base body above the blank, molding the blank onto the base body by pressing at least one of the base body and the preform against the blank, and hardening the blank.

In general, a metallic metal sheet is used for producing a base body. The base body may be made of steel material for example and produced by hot forming and press hardening. The base body may also be made from light metal material. The base body may involve in particular a motor vehicle structure, e.g. a vehicle pillar such as a B pillar. Other examples for use of the base body may involve a roof pillar or other motor vehicle parts such as side rail, cross member, floor panel, transmission tunnel, or lid such as engine hood, door or the like.

At the beginning of the production process for the hybrid part, the metallic base body has already its final geometry, i.e. the production of the actual hybrid part does not alter or only insignificantly alters the shape of the metallic base body.

According to another advantageous feature of the present invention, at least one layer of the fiber material can be pre-impregnated with resin, or resin can be applied upon layer of the fiber material. In the event the fiber material has two stacked layers or more than two layers, such as three or more, each layer of the fiber material can be pre-impregnated with resin, or resin can be applied upon each layer of the fiber material. The layer or layers of fiber material are then cut to size to produce a blank which may involve a preform part that is then placed upon a preform and heated.

The blank has a shape which substantially corresponds to the outer geometric dimensions of a reinforcement patch. The blank may receive a slight arching, i.e. a three-dimensional shape, on the preform through heat impact for example. Subsequently, the base body is positioned above the blank lying on the preform. The term “positioning” relates hereby to a blank that can be placed over or attached or also applied to the preform. In the event of a vehicle pillar, the base body has advantageously a hat-shaped cross section, with the hat shape being placed over the blank that lies upon the preform so that the blank rests against the inner side of the hat shape.

The blank is molded onto the base body by compressing the base body and/or the preform against the blank. The base body assumes hereby the function of an upper pressing tool whereas the preform assumes the function of a lower pressing tool. The inner side of the base body and the blank are brought into contact as they are compressed, if compression has not already taken place as the blank is placed over the preform. As a result, the blank conforms or is shaped to conform to the surface topography of the base body. Subsequently, the blank is hardened and forms a reinforcement patch of fiberglass material.

In accordance with the present invention, a material joint is established between the blank and the inner side of the base body primarily as a result of an escape of material, in particular resin, from the blank as it is compressed with the base body. The resin provides a bond between the base body and the blank. It is, of course, also conceivable to apply additional plastic to the base body and/or blank for realizing the bond and to further increase strength. Also conceivable is a chemical pretreatment of the base body with a primer.

According to another advantageous feature of the present invention, the blank can be heated by heating the preform, or the blank can be heated by a separate heat source. This is beneficial because there is no need to heat the base body in its entirety that would require a substantial energy input into the entire base body, but rather it is only the preform itself or the blank that is placed upon the preform which is heated. Advantageously, the heating device or heat source can be a heat radiator, e.g. an infrared radiator, or heat plate. When using a heat plate, a contact between the heat plate and the blank is established to effect a heat transfer. The targeted heating of only regions of the blank renders the overall process for the production of a motor vehicle hybrid part significantly more cost-efficient, when compared to conventional approaches, as a result of the smaller heat input during execution of the process and significantly reduced costs for acquiring the assembly line in view of heating tools that are smaller in dimension.

According to another advantageous feature of the present invention, the blank can be heated to a temperature between 40° C. and 130° C., preferably 50° C. to 120° C. Currently preferred is a heating of the blank to a temperature of 70° C. to 90° C. As a result, the fiber material, such as, e.g., carbon fibers, glass fibers, aramide fibers, basalt fibers, or metallic fibers in combination with resin allows execution of the compression process and the following hardening process in an optimum manner.

According to another advantageous feature of the present invention, the preform can be heated to a temperature between 150° C. and 180° C. Currently preferred is a heating of the preform to a temperature between 160° C. and 170° C. This ensures that the blank placed upon the preform is able to reach the afore-mentioned temperatures.

According to another advantageous feature of the present invention, the blank can be drawn from a stack of prepreg webs. Prepregs have the advantage that the need for a resin application can be eliminated. Resin already contained in the prepreg can be activated through heat introduction.

According to another advantageous feature of the present invention, the blank can be maintained at the temperature after being heated on the preform or again heated on the preform. In this way, a respective heat introduction is ensured into the hybrid part already formed from the blank and the base body so that the structure contains a residual heat that is available for subsequent further processing. The renewed or multiple heating renders an incremental molding or incremental activation and/or hardening of the resin in the blank possible.

According to another advantageous feature of the present invention, the hybrid part formed from the base body and attached blank can be heated after being pressed against the blank, or the region where the blank is molded onto the base body can be maintained at a retention temperature. The afore-mentioned benefits are also true here.

According to another advantageous feature of the present invention, the hybrid part formed from the base body with attached blank can be transferred to a press tool for further compression-molding the blank with the base body. The transfer into the press tool may be realized already shortly after the blank has been molded onto the base body, with the resin contained in the blank undergoing during the transition period a partial hardening after the blank is compression-molded to the base body.

According to another advantageous feature of the present invention, the blank and the base body can be compression-molded at a temperature between 120° C. and 200° C. Currently preferred is a compression-molding of the blank and the base body at a temperature between 150° C. and 170° C. Compression-molding in this temperature range again provides optimal conditions between malleability of the blank into the base body and subsequent hardening process. Compression-molding also ensures that possible air trappings between the blank and the base body are squeezed out so as to provide a reliable homogenous bond between the blank and the base body.

According to another advantageous feature of the present invention, the press tool can be held shut for a retention time of less than 10 minutes, preferably less than 6 minutes, especially preferred less than 5 minutes, but at least for 1 second. This ensures a reliable compression-molding of the blank with the base body. Depending on the hardening stage of the individual fiber layers and/or the optionally applied adhesive between the blank and the base body, it is possible to realize short cycle times. For example, the blank is able to assume the end contour of the reinforcement patch after being pressed against the preform, wherein the adhesive present between the reinforcement patch and the base body has not hardened as of yet. The following compression process results in a homogenous adhesive layer which is hardened through heat introduction.

According to another advantageous feature of the present invention, the entire hybrid part may be heated during the production process to a temperature of up to 180° C.

According to another advantageous feature of the present invention, a separation film and/or sealing film may be placed between the blank and a die of the press tool, when the base body with attached blank is placed into the press tool. The presence of the separation film prevents escaping excess adhesive and/or resin from bonding the press tool to the hybrid part and/or reinforcement patch. The separation film may involve a one-time film or disposable film or also a film that remains on the structure to provide additional corrosion protection in the transition zone from reinforcement patch to base body. The presence of a sealing film to provide predominantly a sealing function is optional, whereby the sealing film can be configured in such a way that targeted regions are sealed to prevent resin and/or adhesive to escape and cause contamination of the surface of the sealed region. For example, it is conceivable to attach further components onto these regions by a formfit and/or material joint. These regions may involve regions that undergo welding operation and/or formfitting attachment, e.g. in the form of a door retaining strap.

In particular, when the production of a motor vehicle pillar is involved, it is conceivable that the base body is not placed over the blank that lies on the preform but that the heated blank on the preform is formed into the base body. In this case, the base body assumes the function of a bottom die and the preform assumes the function of the top die. The afore-described and subsequent steps are however executed in an analogous manner.

According to another aspect of the present invention, a hybrid part for a motor vehicle includes a metallic base body and a reinforcement patch made of fiber composite having at least one layer containing resin, with the hybrid part being produced by a method according to the present invention. Compared to conventional hybrid parts, the motor vehicle hybrid part according to the invention can be produced more cost-efficiently and with greater precision so as to exhibit better stiffening and crash performance.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a base body and a blank before being molded together;

FIG. 2 is a schematic illustration of the base body and the blank after being molded together; and

FIG. 3 is a schematic manufacturing sequence of a method for producing a hybrid part in accordance with the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

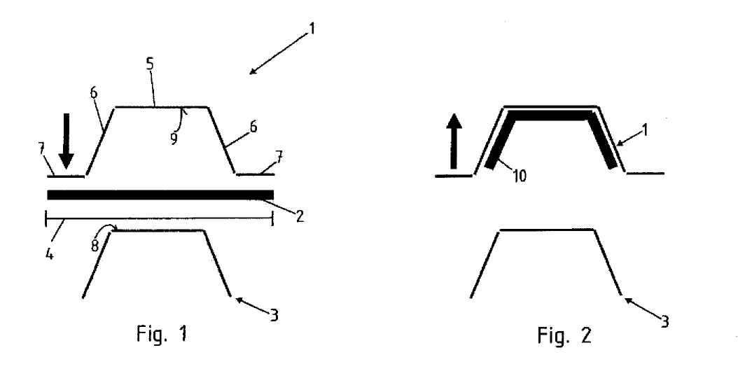

Turning now to the drawing, and in particular to FIG. 1, there is shown a schematic illustration of a base body 1 and a blank 2 placed underneath the base body 1. The blank 2 is placed upon a preform 3. The outer geometric dimensions of the blank 2, depicted here by way of example by width 4, correspond to the geometric dimensions of a reinforcement patch 10 (FIG. 2) to be produced. The base body 1 has a substantially hat-shaped cross section, defined by a bottom web 5 and attached limbs 6 which are continued by flanges 7, respectively. The preform 3 has a forming surface area 8 which substantially corresponds to the inner side 9 of the base body 1. When the blank 2, as illustrated here, is placed upon the preform 3, a lowering of the base body 1 causes the blank 2 to become molded onto or into the base body 1.

FIG. 2 shows the blank 2 being molded into the base body 1 and substantially constituting the produced reinforcement patch 10.

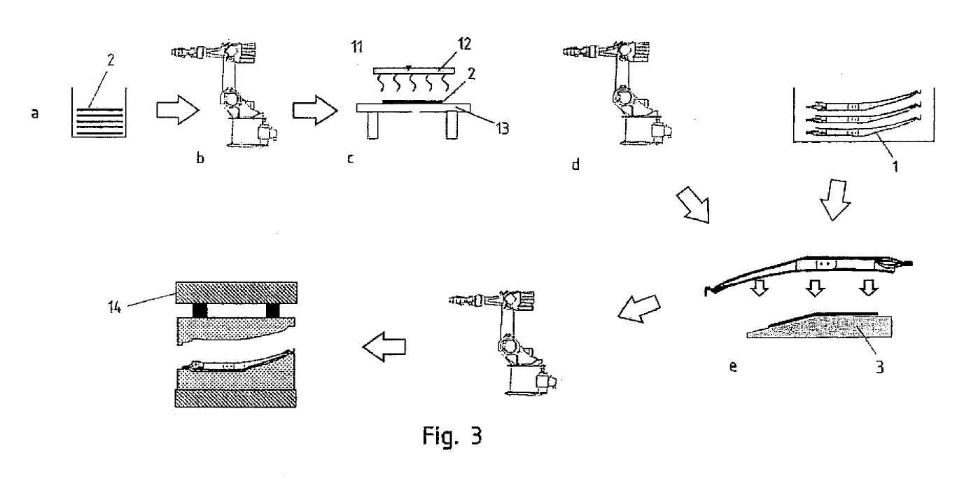

FIG. 3 shows a schematic manufacturing sequence of a method for producing a hybrid part in accordance with the present invention. In the area of position a, stacks of fiber layers or blanks 2 that have been cut to size from the fiber layers are stored. The blanks 2 are transferred by a manipulator in area b to an area c where a heating device 11 is present which may involve for example a heat radiator 12 or a heat plate 13 on which the blank 2 is deposited. Thereafter, a further manipulator in the area d grabs the heated blank 2 and places it onto the preform 3.

It is, of course, also possible within the scope of the present invention, to directly heat the blank 2 on the preform 3 and/or to heat the preform 3 itself. The base body 1 is then positioned above the preform 3 and lowered so that the blank 2 is molded into the base body 1. During a subsequent manipulator operation in the area e, the prefabricated hybrid part comprised of the blank 2 and the base body 1 is transferred by a further manipulator to a press 14 to undergo compression-molding in the press 14. The blank 2 is able to harden during the production process or after the compression-molding process so as to form the reinforcement patch 10 on or in the base body 1.

It is further possible within the scope of the invention to configure the preform 3 in a rotatable manner so that the preform 3 is able to rotate about its own axis so as to be pressable as base body 1 for example into a B pillar as shown. It is also conceivable to arrange active elements in the preform 3, e.g. an ejector which separates the attached fiber blank 2 from the surface of the preform 3 so that the base body 1 with the attached fiber blank 2 can be removed by the manipulator for transfer into the press 14. Other examples of active elements may include actively extendible posts which enable after placement of the base body 1 upon the preform 3 with deposited blank 2 that the blank 2 is pressed or molded or forced against the inner surface area of the base body 1.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method of making a hybrid part of a motor vehicle, said method comprising:
producing a base body in the form of a three-dimensional component;
adding resin to a layer of fiber material;
cutting the fiber material to size for producing a blank;
placing the blank on a preform;
heating the blank on the preform;
positioning the base body above the blank;
molding the blank to the base body by pressing at least one of the base body and the preform against the blank; and
hardening the blank.

2. The method of claim 1, wherein the fiber material includes at least two of such layers which are stacked upon one another.

3. The method of claim 1, wherein the fiber material is pre-impregnated with resin.

4. The method of claim 1, wherein the resin is applied upon the fiber material.

5. The method of claim 1, wherein the blank is heated by heating the preform.

6. The method of claim 1, wherein the blank is heated by a separate heat source.

7. The method of claim 6, wherein the heat source is a heat radiator or heat plate.

8. The method of claim 7, wherein the heat radiator is an infrared radiator.

9. The method of claim 7, wherein the heat plate is placed upon the blank or the blank is placed upon the heat plate

10. The method of claim 1, wherein the blank is heated to a temperature between 40° C. and 130° C., preferably 50° C. to 120° C., especially preferred 70° C. to 90° C.

11. The method of claim 4, wherein the preform is heated to a temperature between 150 and 180° C., preferably between 160° C. and 170° C.

12. The method of claim 1, wherein the blank is drawn from a stack of prepreg webs.

13. The method of claim 10, further comprising maintaining the blank at the temperature after being heated on the preform or reheating the blank on the preform.

14. The method of claim 1, further comprising heating the base body with attached blank after being pressed against the blank or maintaining a region where the blank is molded onto the base body at a retention temperature.

15. The method of claim 1, further comprising transferring the base body with attached blank to a press tool for compression-molding the blank and the base body.

16. The method of claim 15, wherein the blank and the base body are compression-molded at a temperature between 120° C. and 200° C., preferably between 150° C. and 170° C., in the production of a hybrid part.

17. The method of claim 16, wherein the hybrid part is heated during the production to a temperature of up to 180° C.

18. The method of claim 15, wherein the press tool is held shut for a retention time of less than 10 minutes, preferably less than 6 minutes, especially preferred less than 5 minutes, but at least for 1 second.

19. The method of claim 15, further comprising placing a separation film or sealing film between the blank and a die of the press tool, when the base body with attached blank is placed into the press tool.

20. The method of claim 15, wherein the compression-molding in the press tool is executed using a temperature profile which changes as a function of time.

21. The method of claim 1, wherein the molding step includes the step of forming the blank upon the base body.

22. The method of claim 1, wherein the molding step includes the step of forming the blank into the base body.

23. A hybrid part for a motor vehicle, comprising:
a metallic base body; and
a reinforcement patch made of fiber composite having at least one layer containing resin,
said hybrid part being produced by the method of claim 1.
